(19) United States
(12) Patent Application Publication
(10) Pub. No.: US 2026/0332634 A1
(43) Pub. Date: Oct. 22, 2026

(54) SECURITY VISUALIZATION

(71) Applicant: Strong Crypto Innovations LLC, Centreville, VA (US)

(72) Inventors: Alexander Fry, Centreville, VA (US); Conner Rehm, Centreville, VA (US); Hitarth Patel, Centreville, VA (US); Brett Ewing, Centreville, VA (US)

(21) Appl. No.: 19/654,135

(22) Filed: Apr. 21, 2026

Related U.S. Application Data
(60) Provisional application No. 63/792,173, filed on Apr. 21, 2025.

(51) Int. Cl. H04L 9/40; H04L 41/16

(52) U.S. Cl. CPC H04L 63/1433; H04L 41/16

(57) ABSTRACT

A security visualization is generated by receiving an electronic communication that includes first electronic data characterizing a cyber risk associated with a computer system. A cybersecurity evaluation of the cyber risk is then dynamically performed, and a generated security visualization is communicated to a computer output device. In this regard, the cybersecurity evaluation is carried out by generating, by an artificial intelligence process, contextual parameters associated with the cyber risk, based upon the received first electronic data. The cybersecurity evaluation is further carried out by utilizing the contextual parameters to map the cyber risk to a framework, Moreover, the cybersecurity evaluation is carried out by electronically generating a security visualization that maps the cyber risk of the associated computer system, based upon the contextual parameters, the cyber risk mapped to the framework, or both.

This application claims the benefit of U.S. Provisional Patent Application Ser. No. 63/792,173, filed Apr. 21, 2025, having the title “ATTACK TREE VISUALIZATION,” the disclosure of which is hereby incorporated by reference in its entirety, as if expressly set forth herein.

### BACKGROUND

### Field of the Disclosure

Aspects of the present disclosure relate generally to visualization and diagram creation tools and usage thereof. Aspects further relate to artificial intelligence driven security visualization and diagram creation tools for managing cybersecurity threats.

### Description of Related Art

Cybersecurity is a computer discipline that seeks to protect computer systems from computer threats, which can manifest as vulnerabilities, cyber attacks, malware, and other forms of nefarious actions. For example, computer threats can lead to information theft, data corruption, data manipulation, or data destruction. Yet further, computer threads can cause damage to hardware, corrupt executable software, create overall system processing disruptions, slow downs, misdirection, etc. Yet further, computer threats can cause damage to physical structures, persons, and corresponding environments by causing computer controlled devices, machines, robots, etc., to function in unintended ways.

### BRIEF SUMMARY

According to aspects herein, a method is provided, for generating security visualizations. The method comprises receiving an electronic communication that includes first electronic data characterizing a cyber risk associated with a computer system. The method also comprises dynamically performing a cybersecurity evaluation of the cyber risk. In this regard, the cybersecurity evaluation is carried out by generating, by an artificial intelligence process, contextual parameters associated with the cyber risk, based upon the received first electronic data. The cybersecurity evaluation is further carried out by utilizing the contextual parameters to map the cyber risk to a framework. Moreover, the cybersecurity evaluation is carried out by electronically generating a security visualization that maps the cyber risk of the associated computer system, based upon the contextual parameters, the cyber risk mapped to the framework, or both. The method further comprises outputting to a computer output device, the generated security visualization.

In some embodiments, electronically generating the security visualization comprises electronically generating at least one of an attack tree or an attack flow map.

In some embodiments, receiving the first electronic data characterizing the cyber risk, can comprise receiving at least one of electronic data characterizing a threat landscape, electronic data characterizing an attack surface, electronic data characterizing an attack vector, electronic data characterizing a threat vector, electronic data characterizing a security exposure, electronic data characterizing an exposure surface, electronic data characterizing a vulnerability, or electronic data characterizing a vulnerability factor.

Moreover, in some embodiments, receiving the first electronic data characterizing the cyber risk, can comprise at least one of a diagram associated with the cyber risk, data collected from or characterizing the cyber risk, a command output characterizing the cyber risk, a screen shot taken by a user related to the cyber risk, a network diagram related to the cyber risk, evidence of an action (e.g., something the user did, could do, did not do, or could not do), related to the cyber risk, or a prompt for an artificial intelligence process to generate a diagram or aspect of data related to a new or existing cyber risk.

In some embodiments, generating, by the artificial intelligence process, contextual parameters associated with the cyber risk, based upon the received first electronic data, can comprise providing the first electronic data to a digital agent, where the digital agent includes an artificial intelligence process that is trained on building security visualizations based upon attack flow vector data and the framework.

In some embodiments, utilizing the contextual parameters to map the data associated with the cyber risk to the framework can comprise mapping the data associated with the cyber risk to a standard framework (e.g., a framework that has been recognized by an industry being a standard).

In some implementations, electronically generating the security visualization includes editing an existing security visualization to generate a revised security visualization. In other implementations, the security visualization is generated as a new security visualization (e.g., created from scratch, created from an existing security visualization, etc.).

In some embodiments, multiple artificial intelligence technologies can be utilized (e.g., together, or otherwise in cooperation). For instance, receiving the electronic communication by the first computer processing device that includes first electronic data, can comprise receiving a request from a digital agent to create or edit a security visualization based upon data obtained from a user.

As another example, generating, by an artificial intelligence process, contextual parameters associated with the cyber risk can comprise generating contextual parameters related to at least one of user goals, actions, or requirements.

In some embodiments, the artificial intelligence process can comprise a generative artificial intelligence process (e.g., including a diffusion based generative artificial intelligence model, large language model, conversational large language model, etc.). In this regard the process may further comprise implementing the generative artificial intelligence process as general-purpose language model that does not require specific training on the framework. Rather, the generative artificial intelligence process may be trained on examples and context of cyber risks to enable generating the security visualization.

Also, in some embodiments, the artificial intelligence process can comprise at least one generative artificial intelligence process for understanding user context and generating requests for edit to the generated security visualization, and for making edits to the security visualization, based on requests for edit and the context of corresponding cyber risks submitted to the generative artificial intelligence process. Here, the method may further comprise accessing a repository, e.g., which may contain examples of diagrams and components that characterize cyber risks that are available for training the generative artificial intelligence process, and accessing a control system for tracking changes and enabling conflict-free, real-time collaboration among one or more users.

In still other embodiments, the method may further comprise granting the artificial intelligence process access to a control system and using the control system to enable for conflict-free, real-time collaboration among one or more user computer devices and contributions from more than one computer model, the control system tracking changes to the security visualization over time.

According to further aspects herein, a system is provided, for generating security visualizations. The system comprises a computer processing device having a processor and memory, where the processor is configured such that when processor reads instructions stored in the memory, the processor implements code to generate a security visualization. More particularly, the processor implements code to receive an electronic communication that includes first electronic data characterizing a cyber risk associated with a computer system. The processor also implements code to dynamically perform a cybersecurity evaluation of the cyber risk. Here, the processor performs the cybersecurity evaluation by implementing code to generate, using an artificial intelligence process, contextual parameters associated with the cyber risk, based upon the received first electronic data. The processor further performs the cybersecurity evaluation by implementing code to utilize the contextual parameters to map the cyber risk to a framework. Also, the processor performs the cybersecurity evaluation by implementing code to electronically generate a security visualization that maps the cyber risk of the associated computer system, based upon the contextual parameters, the cyber risk mapped to the framework, or both. Still further, the processor implements code to output to a computer output device, the generated security visualization.

In some embodiments of the system, the security visualization is implemented as at least one of an attack tree or an attack flow map.

In some embodiments of the system, the first electronic data includes a description of an attack diagram.

In some embodiments of the system, the framework comprises the MITRE ATT&CK framework.

In some embodiments of the system, the artificial intelligence process generates contextual parameters of the mapping, comprising contextual parameters related to at least one of user goals, actions, or requirements.

In some embodiments of the system, the artificial intelligence process can access a control system, allowing for conflict-free, real-time collaboration among one or more user computer devices and contributions from more than one computer model, the control system tracking changes to the diagram over time.

Aspects herein provide a method for generating security visualizations by electronically receiving a description of a desired diagram and by receiving requirements for mapping to a framework. This method utilizes a natural language computer processing module to derive the context of the mapping and to generate a request for edit. The request for edit is fulfilled by an editing module, which makes edits to the diagram based on the request for edit and the context of the diagram.

Aspects herein further provide a method for generating security visualizations by electronically receiving a description of the desired diagram and by receiving requirements for mapping to a framework. The method utilizes a computer implemented natural language processing module to derive a context of the mapping. A natural language processing module generates a request for edit, including a detailed description of the edit and information on mappings and standards to be adhered to. Security visualizations are generated by receiving the request by an editing module, which makes edits to the diagram based on the request for edit and the context of the diagram and electronically storing the revised diagram in a digital storage module.

Some implementations further allow for real-time collaboration among one or more user computer processing devices and machine learning contributions.

Yet further aspects herein provide a method for collaborative security visualization mapping. Collaborative security visualization mapping is carried out by receiving electronic input from one or more user computer processing devices, including descriptions of attack flows and requirements for mapping to a framework. The method generates over time, multiple requests for edit by a generative artificial intelligence process, where the generative artificial intelligence process derives user context from the received input. Collaborative security visualization mapping is further carried out by generating by an agent large language model, edits to diagrams. Here, the edits to the diagrams are based on the requests for edit and context derived from the generative artificial intelligence process. The revised diagram can be stored, for instance, in a control system (e.g., version control system, audit log, change log, etc.), allowing for real-time collaboration among one or more user processing devices and machine learning contributions.

Aspects herein also provide yet another method for generating security visualizations. The method comprises obtaining, via a computer processing device, first electronic data that defines a desired diagram. The method also comprises obtaining second electronic data that defines requirements for mapping the desired diagram to a framework. Still further, the method comprises dynamically revising a security visualization. The security visualization is revised by generating, by a machine learning model, contextual parameters of the mapping (e.g., user goals, actions, requirements, etc.) and receiving an electronic request for edit by a computer process that implements a digital agent. For instance, the digital agent may have access to a repository of examples of diagrams and components, and/or full context of the diagram itself. Revising the security visualization further comprises electronically outputting by the digital agent, edits to the diagram so as to map the diagram to the framework. In this regard, the edits are based on the received request for edit and the generated contextual parameters of the mapping. Additionally, the method comprises outputting to a computer output device, a revised security visualization having a dynamic mapping to the framework.

For instance, the first electronic data can comprise a description of an attack diagram, and the second electronic data can comprise requirements for the MITRE ATT&CK framework.

In an example implementation, the machine learning model can comprise a conversational large language model, and the digital agent can comprise an agent large language model. For instance, the conversational large language model and agent large language model can be implemented as general-purpose language models that do not require specific training on the framework or diagram components but are instead provided with examples and context to enable editing.

Aspects herein also provide a system for generating security visualizations. The system comprises a computer system that implements a modular computing architecture including a natural language processing module, an editing module, and a storage module. In this regard, the natural language processing module is operatively configured to derive user context and generate requests for edit. The editing module is operatively configured to make edits to diagrams, based on requests for edit and context of the diagram. The storage module is operatively configured to store revised version controlled diagrams, allowing for real-time collaboration among one or more user processing devices and machine learning contributions. In practical applications, the real-time collaboration comprises conflict-free real-time collaboration.

Aspects herein additionally provide a system for generating security visualizations. The system comprises a computer processing device that executes computer code to implement an interface between a natural language processing module and an editing module, where the natural language processing module generates requests for edit and the editing module makes edits to diagrams, wherein the interface is operatively configured to allow for real-time collaboration among one or more users and artificial intelligence contributions.

Aspects herein also provide a system for multi-user collaboration with machine learning support. The system comprises a computer processing system having a conversational large language model for understanding user context and generating requests for edit. The system also has an agent large language model for making edits to diagrams based on requests for edit and context of the diagram. Additionally, the system includes a repository of examples of diagrams and components that are accessible by the agent large language model. Yet further, the system has a control system for tracking changes and optionally enabling real-time collaboration among one or more users. Likewise, aspects herein provide a system for generating security visualizations.

The system comprises a first computer processing device that obtains first electronic data that defines a desired diagram, wherein the first computer device also obtains second electronic data that defines requirements for mapping the desired diagram to a framework. The system also has computer code stored in memory such that when the computer code is read out and executed, the computer code dynamically revises a security visualization. Here, the security visualization is revised by implementing code to generate, by a machine learning model, contextual parameters of the mapping and receive an electronic request for edit by a computer process that implements a digital agent.

In this implementation, the digital agent has access to a repository of examples of diagrams and components, and full context of the diagram itself. Moreover, the security visualization is revised by code to electronically output by the digital agent, edits to the diagram so as to map the diagram to the framework, where the edits are based on the received request for edit and the generated contextual parameters of the mapping. The system further comprises an output device that outputs the revised security visualization having a dynamic mapping to the framework.

### BRIEF DESCRIPTION OF THE SEVERAL VIEWS OF THE DRAWINGS

FIG. 1A illustrates a computing environment for carrying out aspects disclosed herein;

FIG. 1B is a flowchart illustrating an example method, which can be carried out within the computing environment of FIG. 1A;

FIG. 2 is a flowchart illustrating an example method, which can be carried out within the computing environment of FIG. 1A;

FIG. 3 is a flowchart illustrating an example method, which can be carried out within the computing environment of FIG. 1A;

FIG. 4 is a flowchart illustrating an example method, which can be carried out within the computing environment of FIG. 1A;

FIG. 5 is a flowchart illustrating an example method, which can be carried out within the computing environment of FIG. 1A;

FIG. 6 is a block diagram illustrating an example multi-user method, which can be carried out within the computing environment of FIG. 1A; and

FIG. 7 is a schematic diagram illustrating a computing system having a processor coupled to memory, according to aspects herein.

### DETAILED DESCRIPTION

In today's rapidly evolving computer security landscape, the ability to effectively visualize, communicate, and automate security concepts is crucial. In this regard, aspects herein provide methods and systems for generating security diagrams, which may include attack flow maps, attack tree maps, etc., with dynamic mapping to one or more frameworks (including mapping to standard frameworks).

In this regard, aspects herein provide a transformative approach to security visualization that combines a guideline framework with modern code-first principles. This represents a strategic shift from treating attack trees as static diagrams to viewing them as dynamic, version-controlled code that can be automated, analyzed, and enhanced through modern tools including artificial intelligence processes (e.g., artificial intelligence, machine learning, deep learning, generative AI (e.g., large language models, conversational large language models, diffusion models, etc.).

As used herein, the term artificial intelligence process, functions as a “catch all” for any system that enables machines to mimic human behavior. An artificial intelligence processes can include artificial Intelligence, machine Learning, deep learning, generative artificial intelligence, such as (large language models (LLM)s, diffusion models, etc.).

As used herein, an “agent” is an artificial intelligence process that has access to “tools,” which allow the agent to generate calls to collect information relegated to generating security visualizations. These tools can be simple tools, such as writing an edit to an existing applications programming interface. A tool call may also be complex, e.g., allowing the agent to generate its own code and tooling.

In some implementations, select agents may not be powerful enough to handle the context of interpreting user requests and performing reliable edits to complex diagrams. In this regard, two or more agents may be utilized to task share. For instance, a first agent may be responsible for understanding an environment and intent. The first agent uses a call to a second agent, where the second agent is responsible for taking the first agent's request and data to edit or otherwise create a security visualization (e.g., an attack tree or attack flow map, etc.). The second agent may be a stateless call where subsequent calls have no information on the prior call unless it was provided explicitly in the following requests.

As used herein, a “security visualization” is a tool that is utilized to represent an aspect of network security.

For instance, a security diagram can be implemented as an attack flow map. An attack flow map may be implemented as a machine-readable representation (or map) of a sequence of actions and assets. Attack flow maps can include information and/or knowledge about included actions and/or assets. The map can also optionally include or otherwise describe/illustrate an overall flow. Moreover, the attack flow map can represent actions and assets linked by causal relationships. In this regard an attack flow map can be utilized as a directed graph that shows “how” an attacker can move through a network, illustrating the sequence of events, dependencies, and movement.

A security diagram can also be implemented as an attack tree. An attack tree can be implemented as a conceptual diagram that illustrates (often graphically), a variety of ways in which something can go wrong with a computer network, and the reason that something went wrong. For instance, an attack tree can be represented as a hierarchical, visual diagram of potential paths a cyber attacker can take to achieve a specific goal against a computer network/computer system. The attack tree visualization may characterize the attacker's main objective at a root of the diagram. The attack tree visualization may further break a main objective down into subgoals and specific techniques, represented as branches, using basic logic to identify aspects such as security risks, vulnerabilities, weaknesses, combinations thereof, etc., which can be represented as nodes from the root.

Other security visualization formats can also be implemented, e.g., with various layers of detail associated with cyberthreats to a network.

In a practical implementation, a security visualization herein combines a guideline (such as the industry-standard MITRE Adversarial Tactics, Techniques, and Common Knowledge (ATT&CK) framework) with modern code-first principles (such as using artificial intelligence, machine learning, deep learning, generative AI (e.g., large language models, conversational large language models, diffusion models, etc.)) as a visualization engine. ATT&CK was created by the Mitre Corporation, a 501(c)(3) not-for-profit corporation headquartered in Bedform Massachusetts.

As an example, a cybersecurity task can perform a penetration test, vulnerability scan, application security test, security audit, etc. The collected data is mapped through a framework, e.g., the Mitre attack framework. A process then builds a diagram of each step, based upon the framework. For instance, the diagram can illustrate what was performed during the test, what information was returned/discovered, information about what was and what was not accomplished, combinations thereof, etc. The process can map noted network features that were well implemented, as nodes.

In some implementations, features such as color coding can be applied to distinguish features. By way of non-limiting example, color can be utilized to distinguish features such as critical information, information gathered generally, information done well by the network, etc., to explain contextually what each node represents given a particular situation. This can sit on top of a map into the actual Mitre framework that was utilized.

Moving from traditional diagram tools to a code-based approach powered by an artificial intelligence process solves current technical limitations. For instance, solutions herein remove limitations in design flexibility imposed by traditional diagram tools. Solutions herein also dramatically expand multi-user capability. Solutions also provide dramatically faster visualization times, resulting in faster response times, compared to traditional diagram tools. Yet further, solutions herein provide consistent visualizations and diagrams keyed to a standardized framework.

Aspects herein can be utilized in response to an actual cyber threat, or aspects herein can be utilized for cyber attack security risk assessments.

### Environment

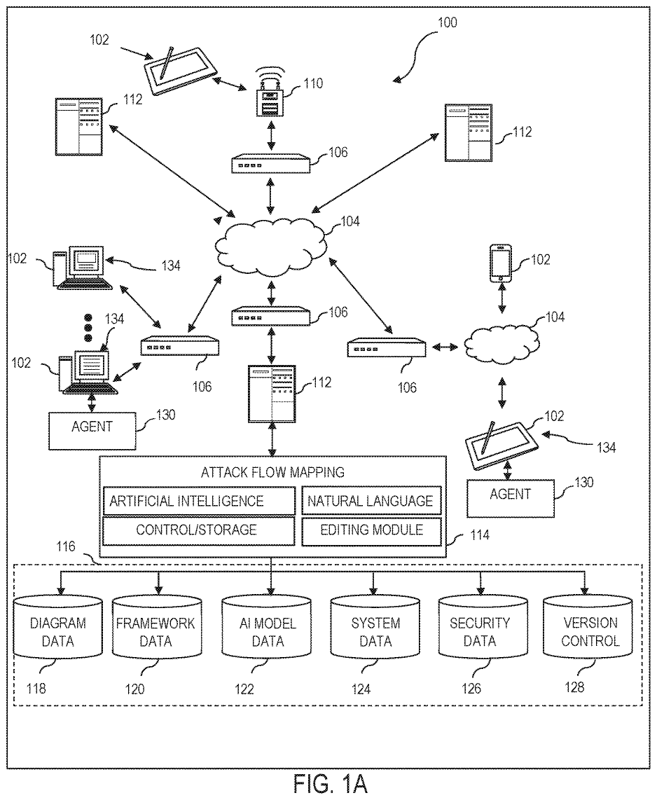

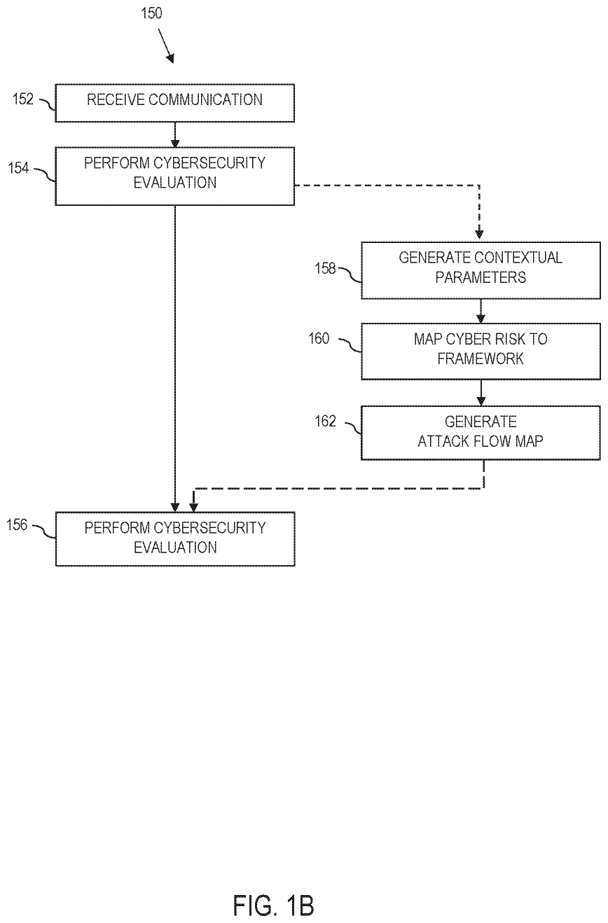

Referring now to the drawings and in particular to FIG. 1A, a general diagram of a computer environment 100 is illustrated according to various aspects of the present disclosure. The computer environment 100 comprises a plurality of hardware and/or software computer processing devices (designated generally by the reference 102) that are linked together by one or more network(s) (designated generally by the reference 104).

Each network 104 provides communications links between the various processing devices 102 and may be supported by networking components 106 that interconnect the processing devices 102, including for example, routers, Wi-Fi routers, hubs, firewalls, network interfaces, wired or wireless communications links and corresponding interconnections, cellular stations and corresponding cellular conversion technologies (e.g., to convert between cellular and TCP/IP, etc.), access points, relays, etc. Moreover, the network(s) 104 may comprise connections using one or more intranets, extranets, local area networks (LAN), wide area networks (WAN), wireless networks (Wi-Fi), the Internet, including the world wide web, cellular and/or other arrangements for enabling communication between the processing devices 102, in either real time or otherwise (e.g., via time shifting, batch processing, etc.). Although numerous examples are provided for sake of illustration, any technology, including future technologies, can be utilized by aspects herein.

Computer processing devices 102 may comprise transactional systems, purpose-driven appliances, special purpose computing devices, general purpose computing devices, and/or other devices capable of communicating over the network 104. In certain contexts and roles, a computer processing device 102 is intended to be mobile, e.g., a smartphone, tablet, laptop, etc. In other implementations, a processing device 102 can be generally stationary, e.g., a desktop computer, server, etc.

Yet further, aspects herein can integrate quantum computing, quantum fiber, bio-compute chips, quantum chips, and other technology and is expressly not limited to the hardware described herein.

The illustrative computing environment 100 also includes a server 112 (e.g., a web server, file server, and/or other processing device) that supports a platform 114 and corresponding data sources (collectively identified as data sources 116). The platform 114 and data sources 116 provide the resources to implement security visualization, including attack flow map and/or attack tree creation, revision, and other features, as described in greater detail herein.

In an exemplary implementation, the data sources 116 are implemented by a collection of databases that store distinct types of information. In the illustrative example, the data sources 116 include databases from multiple, different domains, including a diagram data source 118, a framework data source 120, an artificial intelligence (AI) model data source 122, a system data source 124, a security source 126, and a version control data source 128. Such data sources 116 need not be co-located, and such data need not be logically organized as illustrated. Rather, the illustration herein provides a conceptual/logical framework from which aspects of the present disclosure can be understood. The various data sources 116 are described in greater detail herein.

FIG. 1A also illustrates that some of the computer processing devices 102 can run code that implements a digital agent 130. Examples of the digital agent 130 are described in greater detail herein. Moreover, some processing devices 102 are illustrated with a display 134 for clarity of discussion.

A cyber attack is an attempt to harm or disrupt a computer system, e.g., any of the processing devices 102, the server 112, the the data sources 116, etc. In this regard, cyber attacks can be deliberate, accidental, incidental, or otherwise arise, making cyber attacks more of a concern than ever. Cyber attacks can range from mere nuisance attacks, to attacks that are intended to steal data, gain unauthorized access, plant computer viruses, or otherwise cause damage to the attacked system and/or to cause damage to physical systems controlled by attacked computer system. Cyber attacks can be difficult to identify and difficult to stop once an attack is underway. Due to the complexity of modern computer systems, identifying a cyber attack may not be enough. Detailed visualization of an actual attack, risk of attack, potential attack, hypothetical attack, etc., is critical to remediation.

In this regard, aspects herein do not require that an attack has been materially executed. Rather, evidence of attack vectors may also be utilized to inform of potential attack surface and depth of defenses.

As will be described in greater detail herein, methods and systems are provided for generating attack flow maps with dynamic mapping to frameworks, such as MITRE ATT&CK. The methods herein can utilize artificial intelligence processes (e.g., artificial intelligence, machine learning, deep learning, generative AI (e.g., large language models, conversational large language models, diffusion models, etc.), to understand user context and generate requests for generating security visualizations, which may include generating new visualizations or editing existing visualizations.

In a brief introductory, but non-limiting example, a process may receive a request for edit, i.e., a request to modify an existing security map. Responsive thereto, an agent artificial intelligence process fulfills the request by editing the security map. The agent artificial intelligence process may have access to a repository of examples and full context of the diagram.

The systems herein can enable real-time collaboration among one or more users as well as machine-based contributions, using a control system (e.g., version control system, audit log, change log, etc.) to track changes. Here, the control system need not track versions. Rather, any control implementation can be realized.

Aspects herein provide a text-based format for security documentation that combines ease of use with powerful automation capabilities. Implementation features can include a clean, version-control-friendly structure that supports full CI/CD integration and native standards based mapping (e.g., via the MITRE ATT&CK or other framework mapping). The format can thus offer automated layout and updates, multi-user collaboration with easy merging, and an API-first design for seamless tool integration. In this regard, data structures do not have to be the rendering engine. Rather, the layouts could be performed by the rendering engine based upon data without any layout information stored therein.

Implementations can include a self-documenting code format that is familiar to developers that can scale efficiently with increasing complexity. Aspects herein can also include native support for artificial intelligence processing and automated security validation. The comprehensive solutions herein streamline security documentation processes, enhance collaboration, and ensures up-to-date, accurate security controls in an ever-evolving threat landscape.

### Example of Generating an Attack Flow Map

Referring to FIG. 1B in combination with FIG. 1A, a method 150 for generating security visualizations is provided. The method 150 can be carried out on the illustrative computing environment 100 of FIG. 1A.

The method 150 comprises receiving at 152, an electronic communication that includes first electronic data characterizing a cyber risk associated with a computer system.

For instance, with brief reference to FIG. 1A, a computer operator (e.g., a cyber security specialist) can interact with the server 112 and platform 114 to select, retrieve, provide, or otherwise obtain the first electronic data. For instance, the computer operator can interact with a graphical user interface (GUI), Terminal user interface (TUI), or other interface of a computer processing device 102, to cause the computer processing device 102 to interact with the server 112. As an example, a processing device 102 can interact with the server 112 to obtain first electronic data in the form of data representing a desired diagram (e.g., a description of an attack diagram) from the diagram data source 118.

In some embodiments, receiving the first electronic data characterizing the cyber risk, can comprise receiving at least one of electronic data characterizing a threat landscape, electronic data characterizing an attack surface, electronic data characterizing an attack vector, electronic data characterizing a threat vector, electronic data characterizing a security exposure, electronic data characterizing an exposure surface, electronic data characterizing a vulnerability, or electronic data characterizing a vulnerability factor, etc.

Moreover, in some embodiments, receiving the first electronic data characterizing the cyber risk, can comprise receiving at least one of a diagram associated with the cyber risk, data collected from or characterizing the cyber risk, a command output characterizing the cyber risk, a screen shot taken by a user related to the cyber risk, a network diagram related to the cyber risk, evidence of something (e.g., that the user did, could do, did not do, or could not do), related to the cyber risk, or a prompt for an artificial intelligence process to generate a diagram or aspect of data related to a new or existing cyber risk.

Notably, as used herein, the term “user” can include a human operator, or some proxy thereof. For instance, the proxy may comprise an artificial intelligence process, a sensor, a remote computer system, etc.

The method 150 also comprises dynamically performing, at 154, a cybersecurity evaluation of the cyber risk.

Also, the method 150 comprises outputting, at 156, to a computer output device, a generated security visualization.

In this regard, the cybersecurity evaluation at 154 can be carried out by generating at 158, by an artificial intelligence process, contextual parameters associated with the cyber risk, based upon the received first electronic data.

The cybersecurity evaluation at 154 can be further carried out by utilizing at 160, the contextual parameters to map the cyber risk to a framework.

Moreover, the cybersecurity evaluation at 154 can be carried out by electronically generating, at 162, the security visualization, where the security visualization maps the cyber risk of the associated computer system, based upon the contextual parameters, the cyber risk mapped to the framework, or both.

By way of non-limiting example, by receiving a diagram, the process may build at least a portion of the security visualization out of graph data which can be represented in JSON format. In this context, the artificial intelligence process may write the graph to a database or other persistence method which could later be read and rendered by a different computer system.

In some embodiments, electronically generating the security visualization comprises electronically generating at least one of an attack tree or an attack flow map.

In some embodiments, the artificial intelligence process comprises artificial intelligence, machine learning, deep learning, generative AI (e.g., large language models, conversational large language models, diffusion models, etc.), or a combination thereof.

In some embodiments, generating, by the artificial intelligence process, contextual parameters associated with the cyber risk, based upon the received first electronic data, can comprise providing the first electronic data to a digital agent, the digital agent including an artificial intelligence process that is trained on building security visualizations based upon attack flow vector data and the framework.

In some embodiments, utilizing the contextual parameters to map the data associated with the cyber risk to the framework can comprise mapping the data associated with the cyber risk to a standard framework.

In some implementations, electronically generating the security visualization can comprise editing an existing security visualization to generate a revised security visualization, In other implementations, the security visualization is generated as a new security visualization (e.g., created from scratch).

In some embodiments, multiple artificial intelligence technologies can be utilized. For instance, receiving the electronic communication by the first computer processing device that includes first electronic data, can comprise receiving a request from a digital agent to create or edit an security visualization based upon data obtained from a user.

As another example, generating, by an artificial intelligence process, contextual parameters associated with the cyber risk can comprise generating contextual parameters related to at least one of user goals, actions, or requirements.

In some embodiments, the artificial intelligence process can comprise a generative artificial intelligence process. Here, the processes further implements the generative artificial intelligence process as a general-purpose language model that does not require specific training on the framework and is trained on examples and context of cyber risks to enable generating the security visualization.

Also, in some embodiments, the artificial intelligence process can comprise at least one generative artificial intelligence process for understanding user context and generating requests for edit to the generated security visualization, and for making edits to the security visualization, based on requests for edit and the context of corresponding cyber risks submitted to the generative artificial intelligence process, Here, the method further comprises accessing a repository containing examples of diagrams and components that characterize cyber risks, available for training the generative artificial intelligence process, and accessing a control system for tracking changes and enabling conflict-free, real-time collaboration among one or more users.

In still other embodiments, the method may further comprise granting the artificial intelligence process access to a control system and using the control system to enable for conflict-free, real-time collaboration among one or more user computer devices and contributions from more than one computer model, the control system tracking changes to the security visualization over time.

Aspects herein can implement the above process in a system for generating security visualizations, e.g., as illustrated with reference to FIG. 1A. Here, the system can comprise a computer processing device having a processor and memory. The processor is configured such that when processor reads instructions stored in the memory, the processor implements code to receive an electronic communication that includes first electronic data characterizing a cyber risk associated with a computer system. The processor also implements code to dynamically perform a cybersecurity evaluation of the cyber risk. The cybersecurity evaluation ca be performed by implementing code to generate, using an artificial intelligence process, contextual parameters associated with the cyber risk, based upon the received first electronic data, utilize the contextual parameters to map the cyber risk to a framework, and electronically generate a security visualization that maps the cyber risk of the associated computer system, based upon the contextual parameters, the cyber risk mapped to the framework, or both. The processor can further implement code to output to a computer output device, the generated security visualization.

In some embodiments, the security visualization may be implemented as at least one of an attack tree or an attack flow map.

In some embodiments, the first electronic data includes a description of an attack diagram.

In some embodiments, the framework comprises the MITRE ATT&CK framework.

In some embodiments, the artificial intelligence process generates contextual parameters of the mapping, comprising contextual parameters related to at least one of user goals, actions, or requirements.

In some embodiments, the artificial intelligence process can access a control system, allowing for conflict-free, real-time collaboration among one or more user computer devices and contributions from more than one computer model, the control system tracking changes to the diagram over time.

### Example of Generating an Attack Flow Map

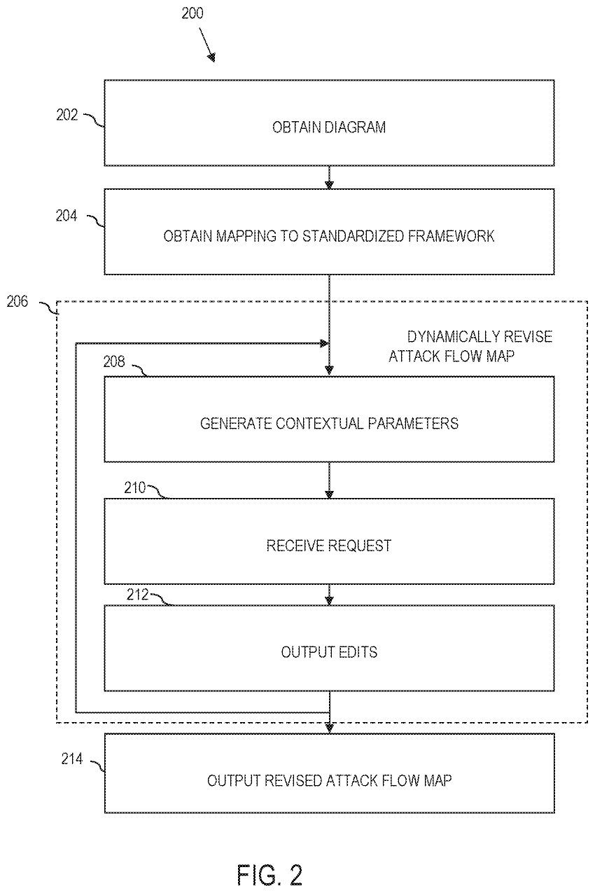

Referring to FIG. 2, a method 200 for generating attack flow maps is illustrated. The method 200 can be implemented, for example, using one or more aspects of the environment 100 (FIG. 1A).

The method 200 comprises obtaining at 202, first electronic data that defines a desired diagram.

For instance, with brief reference to FIG. 1A, a computer operator (e.g., a cyber security specialist) can interact with the server 112 and platform 114 to select, retrieve, provide, or otherwise obtain the first electronic data. For instance, the computer operator can interact with a graphical user interface (GUI), Terminal user interface (TUI), or other interface of a computer processing device 102, to cause the computer processing device 102 to interact with the server 112. As an example, a processing device 102 can interact with the server 112 to obtain data representing a desired diagram (e.g., a description of an attack diagram) from the diagram data source 118.

Referring back to FIG. 2, the method 200 also comprises obtaining at 204, second electronic data that defines requirements for mapping the desired diagram to a framework. By way of example, the second electronic data can comprise a framework such as the MITRE ATT&CK framework. In some implementations, the framework may comprise a framework (e.g., a framework that haw been recognized as a “standard”).

With brief reference back to FIG. 1A, a computer operator (e.g., a cyber security specialist) can interact with the server 112 and platform 114 via a graphical user interface of a computer processing device 102 to select, retrieve, provide, or otherwise obtain the second electronic data. As an example, the processing device 102 can interact with the server 112 to obtain data representing framework data (e.g., data pertaining to the MITRE ATT&CK framework) from the framework data source 120.

Referring back to FIG. 2, the method 200 still further comprises dynamically revising an attack flow map at 206. Here, “dynamically revising” can mean creating, revising, augmenting, adding to, modifying, or otherwise manipulating the attack flow map.

The method dynamically revises the attack flow map by generating at 208, contextual parameters of the mapping. Example contextual parameters of the mapping can include contextual parameters related to at least one of user goals, actions, or requirements In some example implementations, contextual parameters are directed to user goals, actions, and requirements.

In some example implementations, a machine learning model can generate the contextual parameters. For instance, the machine learning model can comprise a large language model. Yet further, a large language model can be implemented as a conversational large language model.

The method 200 further dynamically revises the attack flow map by receiving at 210, an electronic request for edit. For instance, receiving an electronic request for edit can comprise receiving an electronic request for edit that includes a detailed description of the edit and information on mappings and standards to be adhered to.

In an example implementation, the request for edit can be generated by a computer process that implements a digital agent (such as an agent Large Language Model). The digital agent may have access to a repository of examples of diagrams, components, a full context of the diagram itself, combinations thereof, etc. For instance, a digital agent can interact with a conversational large language model to generate the request for edit.

In an example implementation, the machine learning model comprises a conversational Large Language Model, the digital agent comprises an agent Large Language Model, and the method 200 further comprises implementing the conversational Large Language Model and agent Large Language Model as general-purpose language models that do not require specific training on the framework or diagram components but are instead provided with examples and context to enable editing.

Referring back to FIG. 1A, the platform 114 can utilize the LLM model data source 122 to generate a conversational LLM. Optionally, digital agents (e.g., agent 130) can utilize a processing device 102 to log into the platform 114 via the server 112 to interact with the conversational LLM. The method may also access the diagram data 118, and/or framework data 120 as described above. Still further, the method 200 can access the system data source 124 to access data related to a computer environment, historical information, metadata, etc. Also the method 200 may access the security data source 126 to access additional security information, etc.

Referring back to FIG. 2, method further dynamically revises the attack flow map by electronically outputting at 212 (e.g., by the digital agent), edits to the diagram so as to map the diagram to the framework. In this regard, the edits are based on the received request for edit and the generated contextual parameters of the mapping.

The method 200 yet further comprises outputting at 214 (e.g., to a computer output device), the revised attack flow map having a dynamic mapping to the framework.

In some implementations, the method 200 may further comprise granting the machine learning model access to a control system (e.g., see control data source 128, FIG. 1A). The control system can enable allowing for real-time collaboration among one or more user computer devices and contributions from more than one computer model. The control system can also facilitate tracking changes to the diagram over time.

Although described with reference to an attack flow map, the process of FIG. 2 can be applied generally to any security visualization, examples of which are set out in greater detail herein.

### Collaborative Attack Flow Mapping

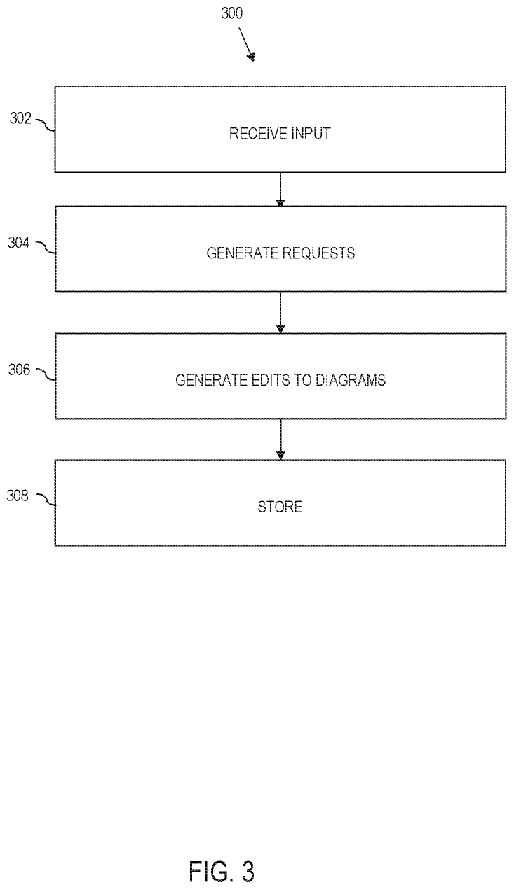

Referring to FIG. 3, a method 300 for collaborative attack flow mapping is illustrated. The method 300 can be implemented, for example, using one or more aspects of the environment 100 (FIG. 1A) and/or by using any features described with reference to the method 200 (FIG. 2) in any combination.

Moreover, although described with reference to an attack flow map, the process of FIG. 3 can be applied generally to any security visualization, examples of which are set out in greater detail herein.

The method 300 comprises receiving at 302, electronic input. For instance, the input can be received from one or more user computer processing devices. The input can include, for example, descriptions of attack flows, requirements for mapping to a framework, combinations thereof etc.

The method 300 also comprises generating over time at 304, multiple requests for edit. The request(s) for edit can be generated for instance, by a conversational large language model. In this example implementation, the conversational large language model can derive user context from the received input.

The method 300 further comprises generating at 306, edits to diagrams. For instance, an agent large language model can generate edits. Moreover, edits may be based on the requests for edit, the context derived from the conversational large language model, or a combination thereof.

The method 300 yet further comprises storing at 308, the revised diagram in a control system control system (e.g., version control system, audit log, change log, etc.). The control system can allow for real-time collaboration among one or more user processing devices and machine learning contributions.

### Example of Generating Attack Flow Maps

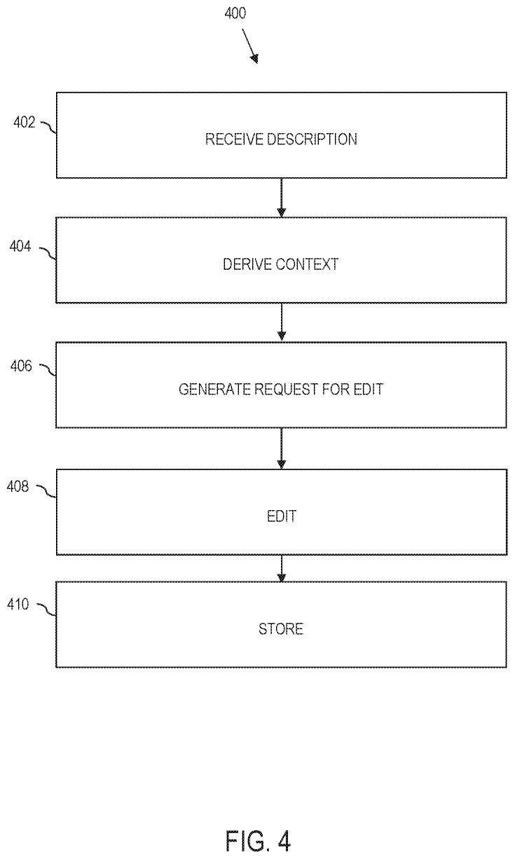

Referring to FIG. 4, a method 400 for generating attack flow maps is illustrated. The method 400 can be implemented, for example, using one or more aspects of the environment 100 (FIG. 1A) and/or by using any features described with reference to the method 200 (FIG. 2) and/or method 300 (FIG. 3) in any combination.

Although described with reference to an attack flow map, the process of FIG. 4 can be applied generally to any security visualization, examples of which are set out in greater detail herein.

The method 400 for generating attack flow maps comprises electronically receiving at 402, a description of the desired diagram and requirements for mapping to a framework. For instance, the received electronic description can include incremental changes to an existing diagram.

The method 400 also comprises deriving at 404, a context. For instance, the method 400 can utilize a computer implemented natural language processing module to derive a context of the mapping (e.g., a context such as user goals, actions, and requirements).

The method 400 also comprises generating at 406, a request for edit. For instance, the request for edit can include a detailed description of the edit and information on mappings and standards to be adhered to. By way of example, the method 400 can generate at 406, a request for edit by a natural language processing module.

The method 400 also comprises receiving at 408 the request by an editing module, which makes edits to the diagram based on the request for edit and the context of the diagram.

The method 400 also comprises electronically storing at 410, the revised diagram. The revised diagram can be stored for instance, in a digital storage module, allowing for real-time collaboration among one or more user computer processing devices and machine learning contributions.

### Additional Example of Generating Attack Flow Maps

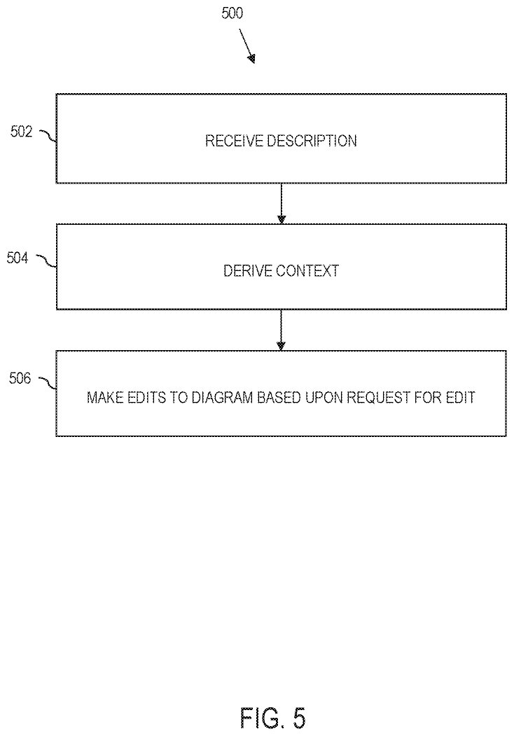

Referring to FIG. 5, a method 500 for generating attack flow maps is illustrated. The method 500 can be implemented, for example, using one or more aspects of the environment 100 (FIG. 1A) and/or by using any features described with reference to the method 200 (FIG. 2) and/or method 300 (FIG. 3) and/or the method 400 (FIG. 4) in any combination.

Although described with reference to an attack flow map, the process of FIG. 5 can be applied generally to any security visualization, examples of which are set out in greater detail herein.

The method 500 comprises electronically receiving at 502, a description of a desired diagram and requirements for mapping to a framework.

The method 500 also comprises utilizing a natural language computer processing module to derive the context of the mapping and generate a request for edit. The request for edit can be fulfilled for instance, by an editing module, which makes edits to the diagram based on the request for edit and the context of the diagram.

The method 500 may allow for real-time collaboration among one or more user computer processing devices and machine learning contributions. The method 500 may also store revised diagrams in a storage module (see data sources 116, FIG. 1A).

### Real-Time Contributions

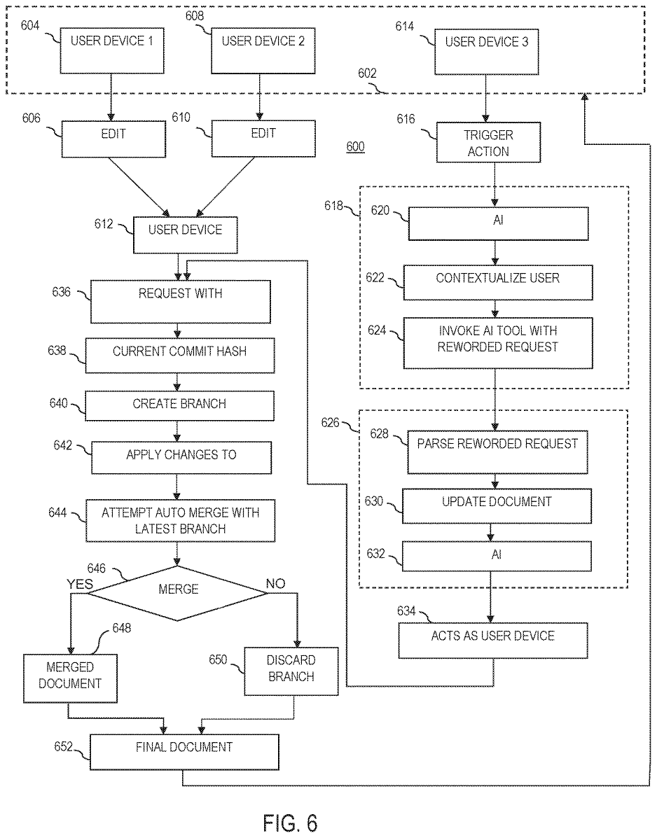

Referring to FIG. 6, as noted more fully herein, aspects provide a computer processing device that executes computer code to implement an interface between a natural language processing module and an editing module, where the natural language processing module generates requests for edit and the editing module makes edits to diagrams in such as way as to enable the interface for real-time collaboration among one or more users and computer generated contributions.

By way of example, a platform 600 enables user computer devices 602 to participate in the creation of attack maps. As an example, a user computer device 604 can submit edits 606. Likewise, a user computer device 608 can submit edits 610. These edits can be submitted in real-time and thus may be serial, parallel, etc. As such, the various edits are treated as edits from a virtual user processing device 612.

On the other hand, user computer processing device 614 can trigger at 616, an action that prompts an an artificial intelligence (AI) process. The AI process 618 utilizes machine learning or other form(s) of AI to evaluate the trigger action at 616. The AI at 620 contextualizes the user computer processing device 614 and invokes an AI tool with a reworded request.

An updater 626 parses the reworded request and any explicit instructions at 628 and updates a document based upon the parsed reworded request. The updater 626 further uses artificial intelligence (AI) at 632 to mimic a user computer device 634.

If there is a discrepancy (e.g., a GIT conflict), the conflict is resolved by implementing a request at 636. The user device current commit hash is obtained at 638. A branch is created at 640 from the obtained current commit hash. The changes are applied at 642, and an attempt is made at 644 to merge with the last branch.

If the merge is successful (MERGE=YES) at 646, then the edits are merged into the document at 648. If the merge is unsuccessful (MERGE=NO) at 646, the branch is discarded at 650. Regardless, a final document is generated at 652. The process continues for each edit regardless of whether the edit is received by an a human (cybersecurity specialist) working on a client computer processing device, or whether the user is a virtual user generated by an automated computer process (e.g., AI process).

### System Examples

Referring back to FIG. 1A, a system for multi-user collaboration with machine learning support, can be implemented. The system includes a computer processing environment (see environment 100). The systems described herein can implement any one or more of the steps described above with reference to the methods herein, in any combination.

The computer environment 100 can utilize an artificial intelligence process for understanding user context and generating requests for edit. For instance, the platform 114 can implement an LLM based upon data read out from the data source 122.

The system also includes an agent large language model 130 for making edits to diagrams, based on requests for edit and context of the diagram. For instance, a computer processing device 102 running an agent 130 can log into the platform 114 of server 112. The agent 130 interacts with the artificial intelligence process of the platform for making edits to diagrams, based on requests for edit and context of the diagram.

The system also includes a repository of examples of diagrams and components, accessible by the agent artificial intelligence process. For instance, see the data sources 116, which include various data storage sources that can store the examples of diagrams and components. The system also includes a control system for tracking changes and enabling real-time collaboration among one or more users.

In some implementations, the conversational Large Language Model and agent Large Language Model can be configured to work together to generate revised attack flow maps with dynamic mapping to a framework (e.g., the MITRE ATT&CK framework).

### Example System 2

In another example implementation, a system for generating attack flow maps can comprise a first computer processing device that obtains, via a graphical user interface, first electronic data that defines a desired diagram. Here, the first computer device also obtains second electronic data that defines requirements for mapping the desired diagram to a framework. For instance, a computer processing device 102 acting as a client can log into the server 112. A GUI on the processing device 102 can be utilized to obtain the first electronic data and the second electronic data (e.g., from the data sources 116). The first electronic data can include a description of an attack diagram. Likewise, the framework can comprise the MITRE ATT&CK framework, as described more fully herein.

The system also includes computer code stored in memory (e.g., memory of the server 112) such that when the computer code is read out and executed, the computer code dynamically revises an attack flow map. The code dynamically revises an attack flow map by implementing code to generate, by a machine learning model, contextual parameters of the mapping.

The code is further operative to receive an electronic request for edit by a computer process that implements a digital agent (e.g., see agent 130), where the digital agent has access to a repository of examples of diagrams and components, and full context of the diagram itself. Yet further, the code is operative to electronically output by the digital agent, edits to the diagram so as to map the diagram to the framework. Here, the edits can be based on the received request for edit and the generated contextual parameters of the mapping.

In some implementations, the electronic request for edit includes a detailed description of the edit and information on mappings and standards to be adhered to.

The system further comprises an output device (e.g., display 134) that outputs the revised attack flow map having a dynamic mapping to the framework.

In some implementations, the machine learning model can generate contextual parameters of the mapping, such as contextual parameters related to at least one of user goals, actions, requirements, or a combination thereof. In some implementations, the contextual parameters are directed to user goals, actions, and requirements.

In some implementations, the machine learning model can be implemented as a large language model, such as a conversational large language model. The conversational large language model can thus be utilized to generate the request for edit. Likewise, the digital agent can comprise an agent large language model.

In some implementations, the machine learning model comprises a conversational Large Language Model, the digital agent comprises an agent Large Language Model, and the conversational Large Language Model and agent Large Language Model are general-purpose language models that do not require specific training on the framework or diagram components but are instead provided with examples and context to enable editing. Yet further, in other implementations, “the conversational Large Language Model” and “agent Large Language Model” define conceptual roles of a single large language model, such that distinct subagents are not required. Rather, processing can be carried out in a single session.

In some implementations, the machine learning model can access a control system, allowing for real-time collaboration among one or more user computer devices and contributions from more than one computer model. Here, the control system tracks changes to the diagram over time.

### Example System 3

In yet another example implementation, a system for generating attack flow maps, comprises a computer system that implements a modular computing architecture including a natural language processing module, an editing module, and a storage module.

The natural language processing module is operatively configured to derive user context and generate requests for edit.

The editing module is operatively configured to make edits to diagrams, based on requests for edit and context of the diagram.

The storage module is operatively configured to store revised version controlled diagrams, allowing for real-time collaboration among one or more user processing devices and machine learning contributions.

### Example 4

In yet another example implementation, a system for generating attack flow maps, comprises a computer processing device that executes computer code to implement an interface between a natural language processing module and an editing module. The the natural language processing module generates requests for edit and the editing module makes edits to diagrams. Herein, the interface is operatively configured to allow for real-time collaboration among one or more users (user computer processing devices) and AI (automated computer generated) contributions. In practical applications, the real-time collaboration comprises conflict-free real-time collaboration.

### Miscellaneous

With reference to the FIGURES generally, various systems and methods are described throughout. In implementation, any one or more features, components, modules, functions, can be utilized interchangeably with any other disclosed embodiment in any combination unless otherwise explicitly noted.

Moreover, reference to revising or generating diagrams, visualizations, etc., can extend to also include the optional consumption of historical static diagrams, that can be analyzed by the AI against what it understands about the current environment being attacked, e.g., based on the attack paths that resulted in successful completion of a tactic with the techniques and procedures that were exercised in the historical test, e.g., initial access, lateral movement, privilege escalation, within the static diagram.

Such an approach provides the ability to consume diagrams that were created previously, including the consumption of a third-party hypothetical attack flow content such as the the MITRE Attack Navigator). Given previous results and hypothetical results, aspects herein can determine the likelihood of success of executing those attack paths, and re-diagram those paths for the current environment so that they can be executed. It does not even have to be the same environment, but attack paths that typically result in success given the preconditions present in the operating environment.

Yet further, aspects herein can begin with an initial access to an environment. For an internal test, initial access could be starting from a rogue asset perspective or an assumed breach (somebody would download malware to their workstation, which results in the adversary having access to the workstation as that user). For an external test, aspects herein can be approaching the client's assets anonymously from the external/outsider/open Internet perspective.

Aspects herein transform attack tree visualization into a code-first approach that deeply integrates with a framework (such as the MITRE ATT&CK framework) while leveraging modern diagram-as-code tools and LLM capabilities. This evolution creates an open, maintainable, and automation-friendly system for generating attack flow maps with dynamic mapping to the framework.

Any of the previously described systems and/or methods can include any one or more of the following features.

Aspects herein provide a clean, text-based format that facilitates easy tracking of changes and version control. Some implementations utilize an application programming interface (API)-first design, facilitating easy integration with various security tools and platforms. Other aspects provide for scalability to handle increasing complexity of security environments and documentation needs. Yet further, some implementations provide self-documenting code format that enhances readability and maintainability.

Some aspects provide full automation support with Continuous Integration/Continuous Delivery (CI/CD) integration, enabling continuous updates and validation of security documentation. For instance, some aspects herein provide for real-time (optionally, conflict-free) collaboration among one or more user computer processing devices and/or machine driven contributions, allowing for more efficient and effective attack flow mapping.

Some aspects provide integration with frameworks that identify the tools, techniques, and procedures used (such as the MITRE ATT&CK framework and/or other frameworks and standards), allowing for seamless mapping of security controls and threats.

Some aspects provide automated layout and updates powered by LLMs and/or Multimodal LLMs, reducing manual effort in maintaining documentation structure. Some implementations provide native support for Large Language Model (LLM) processing, enabling advanced analysis and generation of documentation. Some implementations can utilize general-purpose Large Language Models (LLMs) that do not require specific training on the framework or diagram components, making such implementations more accessible and adaptable to different use cases. Further aspects can provide a conversational LLM that can understand user context and generate requests for edit, allowing for more accurate and precise editing of diagrams. Additional aspects can employ an agent LLM that can make precise edits to diagrams, based on requests for edit and context of the diagram, ensuring that the revised attack flow maps are accurate and consistent with the framework.

Some aspects provide multi-user support with easy merging capabilities, promoting collaborative documentation efforts. Also, some implementations utilize standard code format familiar to developers, lowering the barrier to entry for technical teams. For instance, an open format can encourage community contributions and extensions.

Some implementations can provide automated security validation to ensure accuracy and compliance of documented controls. Also, an open-source core may allow for efficient scaling and customization. Such may also provide extensibility through community-driven development, fostering innovation and adaptability.

Yet further, certain aspects can integrate with a control system control system (e.g., version control system, audit log, change log, etc.), allowing for tracking of changes and enabling real-time collaboration among one or more users, which improves the overall efficiency and effectiveness of the attack flow mapping process. In practical applications, the real-time collaboration comprises conflict-free real-time collaboration.

### Example Computer System

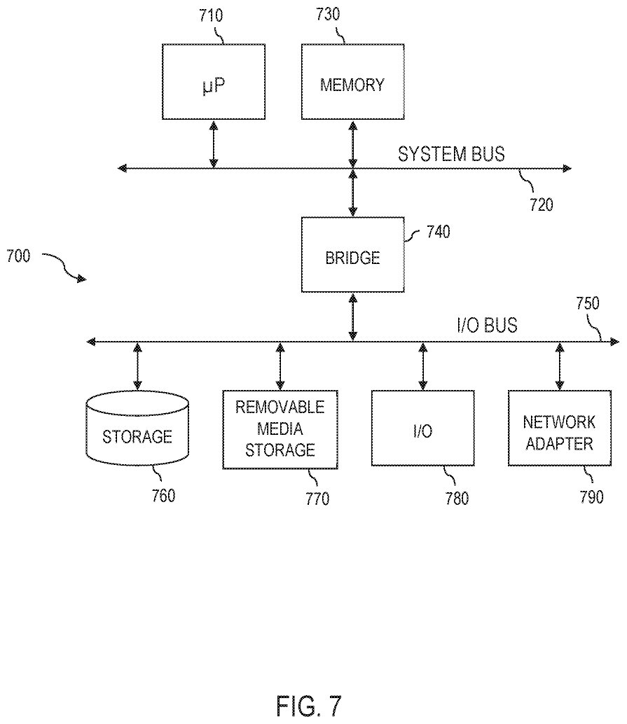

Referring to FIG. 7, a block diagram of a hardware data processing device is depicted in accordance with the present disclosure. The depicted data processing device is a non-limiting example of a processing platform capable of implementing one or more of the functions described with reference to the preceding FIGURES. Data processing device 700 may comprise at least one processor 710 connected to system bus 720. Also connected to the system bus 720 is memory 730. Thus, the processor 710 can read out, and implement code stored in the memory 730. A bridge 740 interfaces the system bus 70 to an I/O bus 750. The I/O bus 750 is utilized to support one or more buses and corresponding devices, such as storage 760, removable media storage 770, input/output devices 780, a network adapter 790, other devices, combinations thereof, etc. For instance, a network adapter 790 can be used to enable the data processing device 700 to communicate with other data processing device or storage devices through intervening private or public networks (e.g., an example of which is set out with regard to FIG. 1A).

The memory 730, storage 760, removable media storage 770, or combinations thereof can be used to store program code that is executed by the processor(s) 710 to implement any aspect of the present disclosure described and illustrated in the preceding FIGURES.

The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

Having thus described the invention of the present application in detail and by reference to implementations thereof, it will be apparent that modifications and variations are possible without departing from the scope of the invention defined in the appended claims.

What is claimed is:

1. A method for generating security visualizations, comprising:
receiving an electronic communication that includes first electronic data characterizing a cyber risk associated with a computer system;
dynamically performing a cybersecurity evaluation of the cyber risk, by:
generating, by an artificial intelligence process, contextual parameters associated with the cyber risk, based upon the received first electronic data;
utilizing the contextual parameters to map the cyber risk to a framework; and
electronically generating a security visualization that maps the cyber risk of the associated computer system, based upon the contextual parameters, the cyber risk mapped to the framework, or both; and
outputting to a computer output device, the generated security visualization.

2. The method of claim 1, wherein:
electronically generating the security visualization comprises electronically generating at least one of an attack tree or an attack flow map.

3. The method of claim 1, wherein receiving the first electronic data characterizing the cyber risk, comprises at least one of:
receiving electronic data characterizing a threat landscape;
receiving electronic data characterizing an attack surface;
receiving electronic data characterizing an attack vector;
receiving electronic data characterizing a threat vector;
receiving electronic data characterizing a security exposure;
receiving electronic data characterizing an exposure surface;
receiving electronic data characterizing a vulnerability; or
receiving electronic data characterizing a vulnerability factor.

4. The method of claim 1, wherein receiving the first electronic data characterizing the cyber risk, comprises at least one of:
a diagram associated with the cyber risk;
data collected from or characterizing the cyber risk;
a command output characterizing the cyber risk;
a screen shot taken by a user related to the cyber risk;
a network diagram related to the cyber risk;
evidence of something the user did, could do, did not do, or could not do, related to the cyber risk; or
a prompt for an artificial intelligence process to generate a diagram or aspect of data related to a new or existing cyber risk.

5. The method of claim 1, wherein:
generating, by the artificial intelligence process, contextual parameters associated with the cyber risk, based upon the received first electronic data, comprises:
providing the first electronic data to a digital agent, the digital agent including an artificial intelligence process that is trained on building security visualizations based upon attack flow vector data and the framework.

6. The method of claim 1, wherein:
utilizing the contextual parameters to map the data associated with the cyber risk to the framework comprises mapping the data associated with the cyber risk to a standard framework.

7. The method of claim 1, wherein:
electronically generating the security visualization comprises editing an existing security visualization to generate a revised security visualization.

8. The method of claim 1, wherein:
electronically generating the security visualization comprises generating a new security visualization.

9. The method of claim 1, wherein:
receiving the electronic communication by the first computer processing device that includes first electronic data, comprises receiving a request from a digital agent to create or edit a security visualization based upon data obtained from a user.

10. The method of claim 1, wherein:
generating, by an artificial intelligence process, contextual parameters associated with the cyber risk comprises generating contextual parameters related to at least one of user goals, actions, or requirements.

11. The method of claim 1, wherein the artificial intelligence process comprises a generative artificial intelligence process, further comprising:
implementing the generative artificial intelligence process as a general-purpose language model that does not require specific training on the framework and is trained on examples and context of cyber risks to enable generating the security visualization.

12. The method of claim 1, wherein the artificial intelligence process comprises:
at least one generative artificial intelligence process for:
understanding user context and generating requests for edit to the generated security visualization; and
making edits to the security visualization, based on requests for edit and the context of corresponding cyber risks submitted to the generative artificial intelligence process;
further comprising:
accessing a repository containing examples of diagrams and components that characterize cyber risks, available for training the generative artificial intelligence process; and
accessing a control system for tracking changes and enabling conflict-free, real-time collaboration among one or more users.

13. The method of claim 1 further comprising:
granting the artificial intelligence process access to a control system and using the control system to enable for conflict-free, real-time collaboration among one or more user computer devices and contributions from more than one computer model, the control system tracking changes to the security visualization over time.

14. A system for generating security visualizations, comprising:
a computer processing device having a processor and memory, the processor configured such that when processor reads instructions stored in the memory, the processor implements code to:
receive an electronic communication that includes first electronic data characterizing a cyber risk associated with a computer system;
dynamically perform a cybersecurity evaluation of the cyber risk, by implementing code to:
generate, using an artificial intelligence process, contextual parameters associated with the cyber risk, based upon the received first electronic data;
utilize the contextual parameters to map the cyber risk to a framework; and
electronically generate a security visualization that maps the cyber risk of the associated computer system, based upon the contextual parameters, the cyber risk mapped to the framework, or both; and
output to a computer output device, the generated security visualization.

15. The system of claim 14, wherein the security visualization is implemented as at least one of an attack tree or an attack flow map.

16. The system of claim 14, wherein the first electronic data includes a description of an attack diagram.

17. The system of claim 14, wherein the framework comprises the MITRE ATT&CK framework.

18. The system of claim 14, wherein the artificial intelligence process generates contextual parameters of the mapping, comprising contextual parameters related to at least one of user goals, actions, or requirements.

19. The system of claim 14, wherein the artificial intelligence process can access a control system, allowing for conflict-free, real-time collaboration among one or more user computer devices and contributions from more than one computer model, the control system tracking changes to the diagram over time.
